(19) United States
(12) Patent Application Publication
(10) Pub. No.: US 2009/0085794 A1
(43) Pub. Date: Apr. 2, 2009

(54) RADAR LEVEL GAUGE SYSTEM

(75) Inventors: Olov Edvardsson, Linkoping (SE); Bjorn Zandersson, Linkoping (SE); Anders Jirskog, Huskvarna (SE)

Correspondence Address: WESTMAN CHAMPLIN & KELLY, P.A., SUITE 1400, 900 SECOND AVENUE SOUTH, MINNEAPOLIS, MN, 55402, US

(73) Assignee: Rosemount Tank Radar AB, Goteborg (SE)

(21) Appl. No.: 11/863,564

(22) Filed: Sep. 28, 2007

(51) Int. Cl. G01S 13/08; G01F 23/00

(52) U.S. Cl. 342/124

(57) ABSTRACT

A radar level gauge system, for determining a filling level of a product contained in a tank, comprising a transceiver configured to transmit and receive electromagnetic signals, a probe arranged to extend towards and into the product inside the tank and configured to guide transmitted signals towards a surface of the product, where signals are reflected, and reflected signals back from the surface of the product. The probe has a mechanical and direct electrical connection to a conductive tank structure. The radar level gauge system further comprises processing circuitry connected to the transceiver and configured to determine the filling level based on the transmitted and reflected signals, and a probe coupling device connected to the transceiver. The probe coupling device includes a first coupling segment configured to couple electromagnetic signals between the transceiver and the probe with a first coupling efficiency and a second coupling segment configured to couple electromagnetic signals between the transceiver and the probe with a second coupling efficiency, the second coupling efficiency being different from the first coupling efficiency.

### TECHNICAL FIELD OF THE INVENTION

The present invention relates to a radar level gauge system, for determining a filling level of a product contained in a tank.

### TECHNICAL BACKGROUND

Radar level gauge systems are in wide use for measuring process variables of products contained in a tank, such as filling level, temperature, pressure etc. Radar level gauging is generally performed either by means of non-contact measurement, whereby electromagnetic signals are radiated towards the product contained in the tank, or by means of contact measurement, often referred to as guided wave radar (GWR), whereby electromagnetic signals are guided towards and into the product by a probe acting as a waveguide. The probe is generally arranged vertically from top to bottom of the tank. The electromagnetic signals are subsequently reflected at the surface of the product, and the reflected signals are received by a receiver or transceiver comprised in the radar level gauge system. Based on the transmitted and reflected signals, the distance to the surface of the product can be determined.

In case of GWR systems, forces, mainly due to friction between the probe and the product contained in the tank, which act on the probe and on the mechanical connection between the probe and the tank, most commonly the tank ceiling, may be very high. For example, in the case of a solid product, such as powders or granules, the probe may be subjected to a pulling force well in excess of 40 kN.

As a consequence, the mechanical connection between the probe and the tank should be designed to be able to withstand such high forces.

Furthermore, an electrical connection between transceiver circuitry of the radar level gauge, which is typically arranged outside the tank, and the probe should be designed with signal propagation performance in mind, such as signal attenuation and/or impedance matching.

The design of a probe coupling device, which provides for electrical coupling between the transceiver circuitry and the probe is essential in achieving the above-mentioned signal propagation performance.

In general, a rather elaborate design of the probe coupling device is needed in order to simultaneously fulfill these mechanical and electrical requirements.

Additionally, the probe may unintentionally act as an antenna, picking up signals which may interfere with measurement circuitry connected to the probe if not properly taken care of.

In an attempt to address the above issues, U.S. Pat. No. 6,856,142 discloses a guided wave radar (GWR) level gauging system in which the probe is in metallic connection with a wall of the tank, such that the tensile forces on the waveguide are absorbed by metallic parts, and interfering signals are dissipated by the conductive bulk of the tank walls. However, the various devices disclosed in U.S. Pat. No. 6,856,142 for coupling signals between the radar level gauge transceiver and the probe are, if at all functional, capable of coupling over a narrow relative bandwidth only. Hereby, the useable frequency range for measurement signals is restricted to very high frequencies, for which the signals are strongly attenuated in the probe.

### SUMMARY OF THE INVENTION

In view of the above-mentioned and other drawbacks of the prior art, a general object of the present invention is to provide an improved radar level gauge system, and in particular a guided wave radar level gauge system which is useable for a wider range of signal frequencies, especially lower signal frequencies for which the signal attenuation is smaller.

According to the present invention, these and other objects are achieved through a radar level gauge system, for determining a filling level of a product contained in a tank, the radar level gauge system comprising: a transceiver configured to transmit and receive electromagnetic signals; a probe arranged to extend towards and into the product inside the tank and configured to guide transmitted signals towards a surface of the product, where signals are reflected, and reflected signals back from the surface of the product, the probe having a mechanical and direct electrical connection to a conductive tank structure; processing circuitry connected to the transceiver and configured to determine the filling level based on the transmitted and reflected signals; and a probe coupling device connected to the transceiver, the probe coupling device including: a first coupling segment configured to couple electromagnetic signals between the transceiver and the probe with a first coupling efficiency; and a second coupling segment configured to couple electromagnetic signals between the transceiver and the probe with a second coupling efficiency, the second coupling efficiency being different from the first coupling efficiency.

In the context of the present application, the “probe” is a waveguide designed for guiding electromagnetic signals. Several types of probes, for example single-line (Goubau-type), and twin-line probes may be used. The probes may be essentially rigid or flexible and they may be made from metal, such as stainless steel, plastic, such as PTFE, or a combination thereof.

The “transceiver” may be one functional unit capable of transmitting and receiving electromagnetic signals, or may be a system comprising separate transmitter and receiver units.

By configuring the radar level gauge system in such a way that direct electrical connection between the probe and a conductive tank structure, such as a wall of the tank when the tank itself is conductive, or a conductive connecting structure, such as a flange or similar when the tank itself is non-conductive, a much wider range of mechanical connections between the probe and the tank become available as compared to conventional GWR type radar level gauge systems. For example, the probe can be attached to the conductive connecting structure by means of screwing or welding, and then to the tank through, for instance, bolting or welding.

The present invention is based on the realization that this wider range of mechanical connections between the probe and the tank can be combined with an electrical connection achieving an increased bandwidth by configuring the probe coupling device in such a way that it includes at least two coupling segments having different coupling efficiencies.

Then, as is well known from the theory of microwave coupling, the overall coupling efficiency and the bandwidth of coupled signals can be controlled by tuning any one of, or a combination of, the following parameters: the number of probe coupling segments, the relation between the coupling efficiencies, and the probe coupling device configuration, for example with respect to the selection of termination.

In particular, proper adaptation of the coupling segments comprised in the probe coupling device enables the use of relatively low frequency measurement signals, such as in the range of 0.5 GHz to 2 GHz with a sufficiently wide relative bandwidth to achieve high-accuracy level measurements.

By using measurement signals having a higher frequency, say 5.8 GHz, a large relative bandwidth is considerably easier to couple between the transceiver and the probe, and a sufficiently large bandwidth for enabling measurement of the filling level may be obtainable even with a probe coupling device having one segment only. At such a high center frequency of the measurement signals, however, the losses in the probe are very large, which typically results in a severely limited measurement range. It is therefore highly desirable to be able to use lower frequency signals.

The above-mentioned different coupling efficiencies can be realized in any manner which enables one coupling segment to couple stronger to the probe than another coupling segment. This can, for example, be accomplished by connecting one coupling segment to the probe through any one of a lower resistance, a higher capacitance and a larger inductance, or a combination thereof, than another coupling segment.

In various embodiments, the probe coupling device may comprise at least three coupling segments, which may be spaced apart along the probe in a longitudinal direction thereof. In case an even wider bandwidth coupling is desired, additional segments may be added. Furthermore, an odd number of segments is generally preferred.

According to one embodiment, each of the coupling segments may extend essentially in parallel with the probe over a distance of substantially a quarter of a wavelength of a center frequency of the electromagnetic signals. It should be noted that this distance is the so-called electrical distance, and depends on the properties of the medium/media between the coupling segment(s) and the probe. The distance of a quarter of a wavelength referred to above should thus be interpreted according to the following expression:

$$D = \frac{λ}{4 \sqrt{{ɛ}_{r}}} , \qquad ( 1 )$$

where D is the distance, A is the wavelength, and εᵣ is the relative permittivity of the medium/media between the coupling segment and the probe.

By means of such a so-called coupled transmission line directional coupler, wideband coupling with a high overall coupling efficiency can be obtained by suitably tuning the coupling efficiencies of the different coupling segments in relation to each other.

How to obtain such a wideband coupling is, for example, detailed in the textbook “Microwave Filters, Impedance-matching Networks, and Coupling Structures” by G Matthaei, L Young, and E M T Jones, reprinted by Artech House, Inc, 1980, and originally published by McGraw-Hill Book Company, Inc, 1964, pp 776-842.

The different coupling efficiencies for the different coupling segments can, for example, be realized by configuring the probe coupling device in such a way that the different coupling segments are provided at different electrical distances from the probe. This can, for example, be accomplished by providing the different coupling segments at different physical distances from the probe and/or interposing dielectrica having different permittivities between the coupling segments and the probe.

Alternatively, or in combination with the above configuration, the different coupling efficiencies can be realized by providing a coupling enhancing member to increase the coupling efficiency between one or several selected coupling segment(s) and the probe. The coupling enhancing member may, for example, be a conductive structure which is provided between the selected coupling segment(s) and the probe whereby the electrical distance between the selected segment(s) and the probe is decreased, and the coupling efficiency/efficiencies consequently increased.

Alternatively, or in combination, the coupling enhancing member may be provided in the form of a loop around the coupling segment(s) in question and the probe.

According to another embodiment, each of the coupling segments may be mutually spaced apart by an electrical distance of substantially a quarter of a wavelength of a center frequency of the electromagnetic signals.

Also in this embodiment, a certain coupling segment may be configured to have a higher coupling efficiency to the probe than an adjacent coupling member, and, similarly to what was described above, this higher coupling efficiency can be achieved by configuring the coupling segment in question to exhibit a higher capacitive and/or inductive coupling with the probe. In analogy with what is described above, this is achievable, for example, by positioning that particular segment(s) (electrically) closer to the probe and/or appropriately providing a coupling enhancing member.

Furthermore, the transceiver comprised in the radar level gauge system may be configured to transmit and receive electromagnetic signals modulated on a carrier, which may advantageously have a frequency above 0.5 GHz and below 2 GHz.

According to a further embodiment, the radar level gauge system may additionally comprise at least a first sensing device for sensing at least a first additional process variable of the product.

Additional process variables (in addition to the filling level) of a product contained in a tank include, for example, temperature, pressure, flow, optical transmittance, acidity, water content, electrical conductivity etc. It should be noted that the values of these additional process parameters may typically be position dependent.

By measuring the value(s) of one or several such additional process variables, the accuracy of the filling level measurement can be improved. Furthermore, an additional process variable may give valuable information about the product in addition to the filling level, such as the quality and/or purity of the product in question.

Advantageously, the probe may comprise a hollow probe part for encasing electric wiring between the sensor and a through-connection provided in the tank wall.

Hereby, the hollow probe part can be used as a wiring duct in which wiring can be arranged without influencing the ability of the probe to guide electromagnetic signals.

Moreover, the radar level gauge system according to the present invention may further comprise a second sensing device connected to the probe for sensing a second additional process variable of the product.

This second sensing device may share wiring with the first sensing device, or may use separate wiring for its connection to the outside of the tank. In the latter case, the separate wiring may be enclosed by the same or a different hollow probe part.

### BRIEF DESCRIPTION OF THE DRAWINGS

These and other aspects of the present invention will now be described in more detail, with reference to the appended drawings showing a currently preferred embodiment of the invention, wherein:

FIG. 1 is a schematic illustration of a radar level gauge system according to an embodiment of the invention;

FIG. 2 is a schematic block diagram of the radar level gauge system in FIG. 1;

FIGS. 3a-b schematically illustrate exemplary electromagnetic measurement signals transmitted and received by the radar level gauge system in FIGS. 1 and 2.

FIG. 4a shows an exemplifying measurement signal in the form of a pulse used for level determination in a radar level gauge system;

FIG. 4b shows the pulse in FIG. 4a modulated on a “low” frequency carrier;

FIG. 4c shows the pulse in FIG. 4a modulated on a “high” frequency carrier;

FIG. 5 is a graph schematically illustrating signal attenuation experienced by a guided wave radar (GWR) level gauge system as a function of signal frequency, as well as respective typical frequency ranges for the signal configurations illustrated in FIGS. 4a-c;

FIG. 6a schematically illustrates an exemplary microwave coupling device having a single coupling segment, and a typical coupling spectrum for such a coupling device;

FIG. 6b schematically illustrates an exemplary microwave coupling device having multiple coupling segments, and a typical coupling spectrum therefor;

FIGS. 7a-d schematically illustrate different exemplary embodiments of the probe-coupling device in FIG. 2 having three coupling segments, each extending a distance corresponding to a quarter of the signal wavelength along the probe;

FIG. 8 schematically illustrates an exemplary embodiment of the probe-coupling device in FIG. 2 having three coupling segments, being mutually spaced apart along the probe by a distance corresponding to a quarter of the signal wavelength; and

FIG. 9 is a schematic illustration of a radar level gauge system, which is configured to determine an additional process variable of the product contained in the tank.

### DETAILED DESCRIPTION OF PREFERRED EMBODIMENTS OF THE INVENTION

In the present detailed description, various embodiments of the radar level gauge system according to the present invention are discussed with reference to a guided wave radar (GWR) level gauge system utilizing a rigid single line (or Goubau) probe. It should be noted that this by no means limits the scope of the present invention, which is equally applicable to various other kinds of probes, such as two-lead probes, flexible probes, etc.

Furthermore, reference is mainly made to filling level determination by means of measuring the time between transmitted and reflected pulses. As is, however, evident to the person skilled in the relevant art, the teachings of the present invention are equally applicable to radar level gauge systems utilizing phase information for determining the filling level through, for example, frequency-modulated continuous wave (FMCW) measurements. When pulses modulated on a carrier are used, phase information can also be utilized.

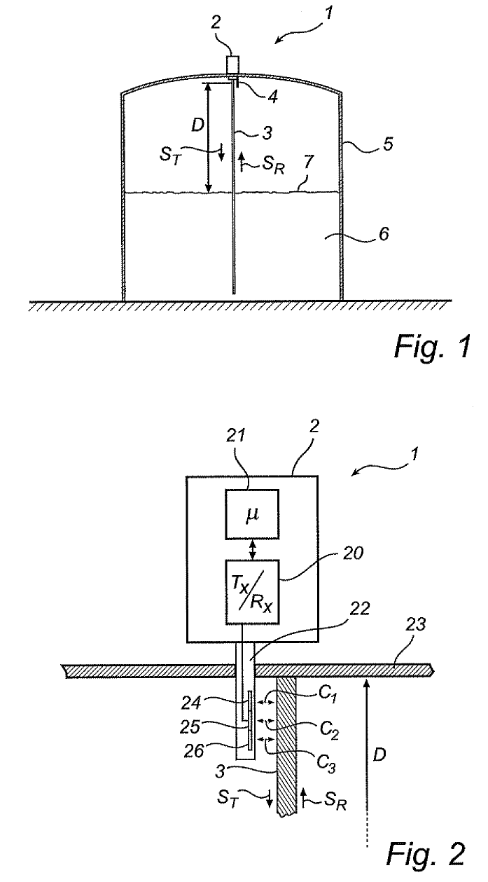

FIG. 1 schematically illustrates a radar level gauge system 1 according to an embodiment of the present invention, comprising a measurement electronics unit 2, a probe 3, and a probe coupling device 4 for coupling electromagnetic signals between the measurement electronics unit 2 and the probe 3. The radar level gauge system 1 is provided on a tank 5, which is partly filled with a product 6 to be gauged. By analyzing transmitted signals S_{T} being guided by the probe 3 towards the surface 7 of the product 6, and reflected signals S_{R} traveling back from the surface 7, the measurement electronics unit 2 can determine the distance D between a reference position (such as the tank ceiling) and the surface 7 of the product 6, whereby the filling level can be deduced. It should be noted that, although a tank 5 containing a single product 6 is discussed herein, the distance to any material interface along the probe can be measured in a similar manner.

The radar level gauge system in FIG. 1 will now be described in more detail with reference to the schematic block diagram in FIG. 2.

In FIG. 2, the measurement electronics unit 2 is shown to comprise a transceiver 20 for transmitting and receiving measurement signals, and processing circuitry 21 for determining a filling level based on the transmitted S_{T} and received S_{R} signals.

As is schematically illustrated in FIG. 2, the transceiver 20 is connected to the probe coupling device 4 through a through-connection 22 provided in the ceiling 23 of the tank 5.

The probe coupling device 4 comprises a number of coupling segments 24, 25, 26, each configured to couple electromagnetic signals to the probe 3 with a respective coupling efficiency C₁, C₂, C₃.

In the presently illustrated exemplary embodiment, the probe 3 is in metallic connection with the tank ceiling 23 whereby a very strong and durable fastening of the probe 3 to the tank ceiling 23 can be accomplished. Such a fastening does, according to the present embodiment, not have to be designed with any particular electrical considerations in mind, and can be virtually freely designed in any conventional and well-known way, such as via a flange bolted to the tank, through welding or through a threaded connection. The details of this fastening are therefore not explicitly illustrated herein.

By tuning the coupling efficiencies C₁, C₂, C₃ of the coupling segments 24, 25, 26 in relation to each other and with respect to the properties of the electromagnetic signals to be coupled, the overall coupling performance of the probe coupling device 4 can be adapted to the desired signal configuration, as will be discussed in greater detail below.

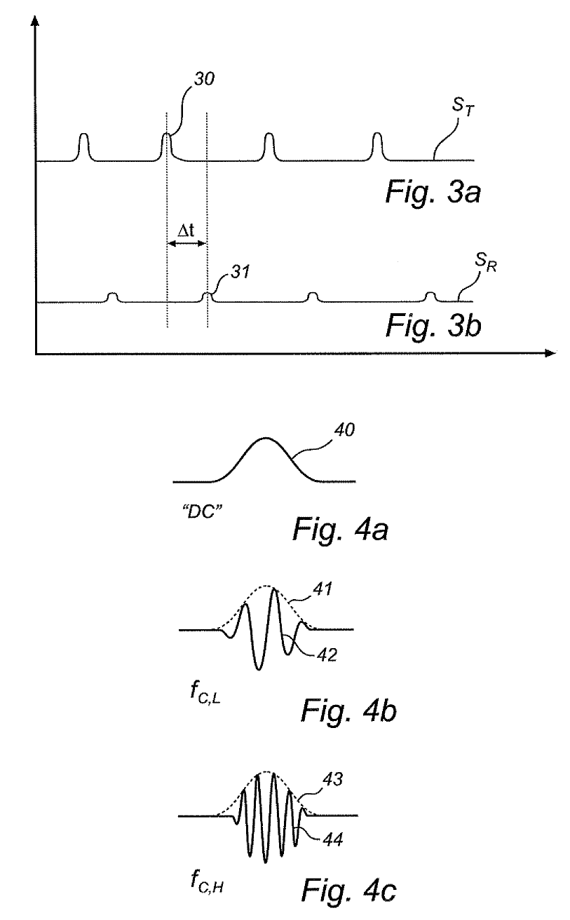

FIGS. 3a-b schematically illustrate exemplary electromagnetic measurement signals transmitted and received by the radar level gauge system in FIGS. 1-2.

In FIG. 3a, transmitted measurement signals S_{T}, here in the form of pulses, are schematically shown, and in FIG. 3b, the received signals S_{R} following reflection at the product surface 7 are shown.

In FIGS. 3a-b, the time difference between a transmitted pulse 30 and its reflection 31 is denoted Δt. From this time-difference Δt, the distance D to the surface 7 of the product 6 contained in the tank 5 can be determined by the processing circuitry 21 in the measurement electronics unit 2.

Even when discussing the limited application field of pulsed systems, the operation of which is schematically illustrated in FIG. 3, several selections of signal configurations can be made depending on the application and its requirements on such factors as measurement accuracy measurement range, power consumption etc.

This is schematically illustrated in FIGS. 4a-c, showing three exemplary ways of achieving the same “pulse”, wherein each of the resulting pulses is associated with its own set of properties and requirements.

First, in FIG. 4a, a so-called DC-pulse 40 is illustrated. Using this DC-pulse 40, the time-difference Δt is used to determine the distance D to the surface 7 of the product 6. As will be further discussed below, the DC-pulse has a number of drawbacks which limit the obtainable measurement accuracy and imposes special requirements on the coupling between the transceiver 20 and the probe 3.

Second, in FIG. 4b, a corresponding pulse 41 is shown modulated on a carrier 42 having a “low” center frequency f_{c,L}. By a “low” frequency should here be understood below approximately 2 GHz.

Third, in FIG. 4c, a corresponding pulse 43 is shown modulated on a carrier 44 having a “high” center frequency f_{c,H}. By a “high” frequency should here be understood a frequency well above 2 GHz, say 4-6 GHz.

For a given pulse width t_{PW}, the absolute bandwidths for the pulses 40, 41, and 43 in FIGS. 4a-c are equal. However, the relative bandwidths may differ greatly depending on the center frequency f_{c} of the carrier. The relative bandwidth can be expressed according to the following relation:

BWᵣₑₗ=(fₘₐₓ−fₘᵢₙ)/f_{c}, where
fₘₐₓ is the maximum frequency,
fₘᵢₙ is the minimum frequency, and
f_{c} is the center frequency, f_{c}=(fₘₐₓ+fₘᵢₙ)/2.

Given an exemplary pulse width t_{PW} of 1 ns for each of the pulses 40, 41, 43 illustrated in FIGS. 4a-c, this relative bandwidth typically differs considerably depending on the center frequency of the carrier frequency (if any). Assuming that the above-mentioned “low” center frequency f_{c,L} is 1.5 GHz, and that the “high” center frequency f_{c,H} is 4.8 GHz, the following relative bandwidths are required to form the desired pulse shape:
DC-pulse: BW_{rel,DC} approaching 200%;
Modulated pulse, “low” frequency: BW_{rel,L} approx 67%:
Modulated pulse, “high” frequency: BW_{rel,H} approx. 20%.

As evident from the illustrative examples given above, coupling of the DC-pulse 40 from the transceiver 20 to the probe 3 imposes higher requirements on relative bandwidth on the probe coupling device 4 than does the pulse 43 modulated on a carrier 44 having a “high” center frequency f_{c,H}.

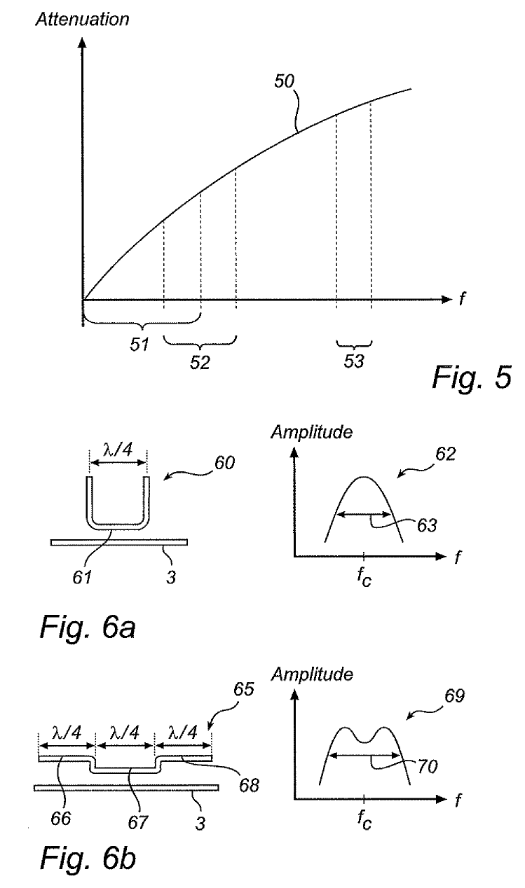

Simply modulating the pulse 43 on a carrier 44 having a high center frequency f_{c,H} to thereby enable the use of a simple narrow band probe coupling device, however, has a negative impact on other important aspects of the radar level gauge system 1. This will be illustrated in the following with reference to FIG. 5, which is a graph schematically illustrating signal attenuation experienced by a guided wave radar (GWR) system as a function of signal frequency, as well as respective typical frequency ranges for the signal configurations illustrated in FIGS. 4a-c.

In FIG. 5, a typical plot 50 of the attenuation along the probe 3 of the transmitted signal S_{T} with respect to signal frequency f is shown for an exemplary situation. As can be seen in FIG. 5, the signal attenuation with respect to the three pulses 40, 41, 43 discussed above, is the lowest for the frequency range 51 corresponding to the DC-pulse. For the frequency range 52 corresponding to the pulse 41 modulated on a “low” frequency carrier 42, the attenuation is stronger, and for the frequency range 53 corresponding to the pulse 43 modulated on a “high” frequency carrier 44, an even stronger attenuation is experienced.

Although it is easier to accomplish a sufficiently good coupling from the transceiver 20 to the probe 3 of the pulse 43 modulated on a “high” frequency carrier 44, a drawback is consequently that, due to the higher degree of attenuation, the measurement range is limited and/or more power needs to be transmitted.

On the other hand, the DC-pulse 40 experiences the least amount of attenuation along the probe 3, but requires the probe coupling device 4 to couple signals over a very large relative bandwidth.

If the pulse 41 modulated on a “low” frequency carrier 42 could be coupled sufficiently well by the probe coupling device 4, a good trade-off between signal attenuation and requirements on the probe coupling device 4 could be obtained.

It will now be demonstrated, with reference to FIGS. 6a-b how a probe coupling device 4 can be configured to couple a sufficient relative bandwidth to enable use of measurement signals enabling an acceptable measurement range and accuracy.

In FIG. 6a, a microwave coupling device 60 having a single quarter-wave (λ/4) coupling segment 61 is shown to couple signals to a schematic probe 3, together with a graph 62 schematically illustrating a typical coupling spectrum as a function of frequency which can be obtained with the microwave coupling device 60. As evident from FIG. 6a, the single λ/4-segment microwave coupling device 60 couples electromagnetic signals over a narrow frequency interval centered around the center frequency of the signal to be coupled (for which the microwave coupling device 60 is configured). Note that the bandwidth 63 in the graph 62 of FIG. 6a represents the above-discussed relative bandwidth. Accordingly, the single λ/4-segment microwave coupling device 60 may be useable for coupling the pulse 43 which is modulated on a “high” frequency carrier 44, but not for any of the other pulses 40, 41 discussed above, both having considerably wider relative bandwidths than the “high” frequency pulse 43. The same reasoning holds for other types of measurement signals, such as frequency modulated FMCW-signals.

In FIG. 6b, a schematic microwave coupling device 65 is shown, comprising three λ/4-segments 66, 67, and 68. The microwave coupling device 65 is positioned adjacent to a schematically illustrated probe 3 in order to couple electromagnetic signals between a transceiver (not shown) connected to the microwave coupling device 65 and the probe 3.

The center λ/4-segment 67 is configured to couple signals between the transceiver and the probe 3 with a higher coupling efficiency than its neighbors 66, 68, here illustrated by positioning the center λ/4-segment 67 closer to the probe 3, thereby increasing the strength of the coupling between the coupling segment 67 and the probe 3.

The multi-segment microwave coupling device 65 shown in FIG. 6b is dimensioned to couple signals with the same center frequency as the coupling device 60 in FIG. 6a. As can be seen in the graph 69, signals can, however, be coupled over a considerably wider relative bandwidth 70 than is possible with the microwave coupling device 60 in FIG. 6a.

Consequently, the use of a probe coupling device 4 having multiple suitably configured coupling segments enables the use of lower frequency measurement signals (pulses or frequency modulated continuous signals), which, in turn, entails a lower signal attenuation along the probe 3 and thereby an improved measurement range and/or a lower current consumption, and a higher measurement accuracy.

It should be noted that an even further increase in the relative bandwidth of a microwave coupling device such as that described above is obtainable by increasing the number of coupling segments. For example, a “pure” DC-pulse 40, such as that illustrated in FIG. 4a should be possible to couple sufficiently well between the transceiver 20 and the probe by means of a probe coupling device 4 having around 6 to 8 appropriately adapted coupling segments.

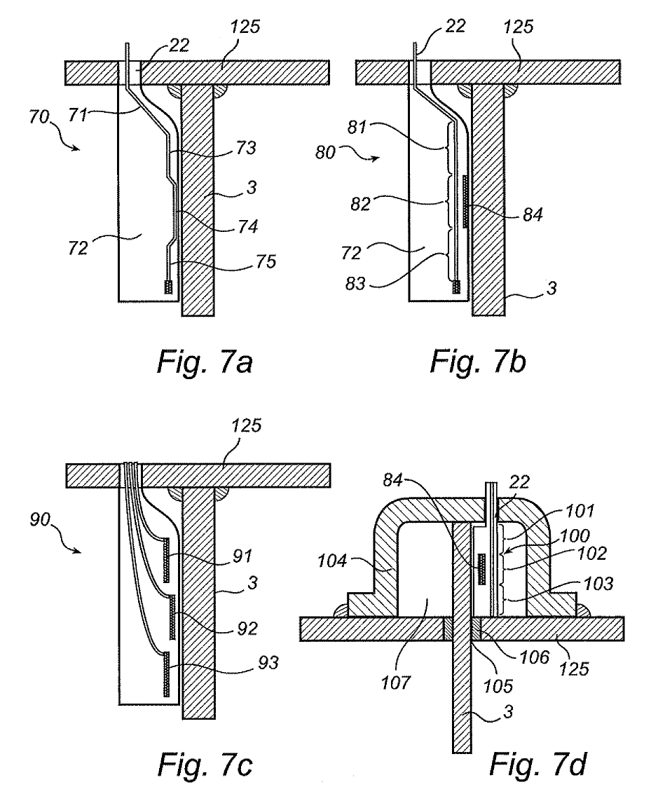

Having demonstrated and explained the basic concept of the probe coupling device 4 comprised in the radar level gauge in FIGS. 1 and 2, different practical exemplary embodiments of the probe coupling device 4 will now be described with reference to FIGS. 7a-d.

In FIG. 7a, a first exemplary probe coupling device 70 is shown. The probe coupling device 70 is connected to a transceiver (not shown) through a through-connection 22 provided in a flange 125 for connection to the tank ceiling 23. The probe coupling device 70 according to the present example is implemented as conductor traces 71 on a circuit board 72. For protection against the environment in the tank, the circuit board 72 may be covered with a protective substance, such as PTFE or similar. Such a protective cover is, however, not shown here.

The probe coupling device 70 is positioned adjacent to the probe 3 which is in metallic connection with the tank ceiling 23 via the flange 125. Signals are coupled between the transceiver (not shown) and the probe 3 through the coupling segments 73, 74, 75, which are preferably λ/4-segments, and the center coupling segment 74 is arranged at a shorter distance from the probe 3 than are its neighbors 73, 75, such that the center coupling segment 74 couples signals with a higher coupling efficiency. As discussed above in connection with FIG. 6b, this probe coupling device 70 configuration leads to a higher relative bandwidth of the probe coupling device 70 than is obtainable with a simpler microwave coupling device 60 having a single coupling segment.

In FIG. 7b, a second exemplary probe coupling device 80 having three coupling segments 81, 82, 83 is shown, which differs from the first exemplary probe coupling device 70 described above in that the higher coupling efficiency of the center coupling segment 82 is achieved by arranging a coupling enhancing member 84, here in the form of a conductive structure provided on the circuit board 82, to provide a stronger capacitive and/or inductive coupling between the center coupling segment 82 and the probe 3 than between the other coupling segments 81, 83, not being assisted by the coupling enhancing member 84 and the probe 3.

In FIG. 7c, a third exemplary probe coupling device 90 having three coupling segments 91, 92, 93 is shown, which differs from the first exemplary probe coupling device 70 described above in that the coupling segments 91, 92, 93 are connected in parallel rather than in series.

In FIG. 7d a fourth exemplary probe coupling device 100 having three coupling segments 101,102,103 is shown, which differs from the second exemplary probe coupling device 80 described above in that the probe 3 is attached to the tank ceiling 23 via a mechanical coupler 104 which is attached to the flange 125 for connection to the tank ceiling 23. The probe 3 protrudes through the flange 125 through a corresponding hole 105 provided therein. This hole may, if desired, be sealed by a simple seal 106 which may be made of rubber, PTFE or any other suitable material. The probe coupling device 100 is provided adjacent to the probe 3 inside the cavity 107 formed by the mechanical coupler 104 and the flange 125. Hereby, the probe coupling device 100 is, to a certain extent, protected from the product 6 contained in the tank, and the probe 3 is still connected to the tank ceiling 23 by a sufficiently strong metallic mechanical connection.

Through the probe coupling configuration illustrated in FIG. 7d, measurement of a product level/interface closer to the tank ceiling 23 is enabled compared to the probe coupling configurations illustrated in FIGS. 7a-c, in which the probe coupling device typically extends below the tank ceiling 23.

It goes without saying that many variations of the above-described exemplary embodiments are possible and can be implemented by the skilled person, without departing from the scope of the present invention, as defined by the enclosed claims.

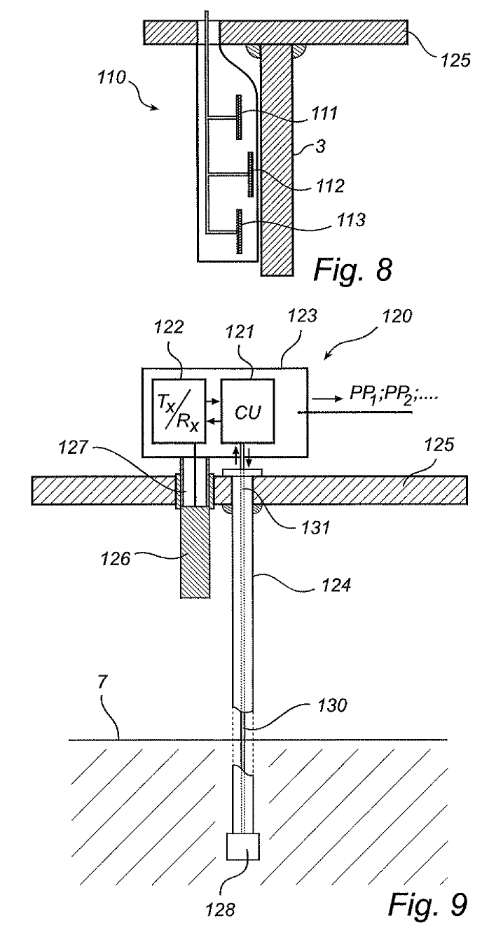

So far, various probe coupling devices having multiple coupling segments each having an extension along the probe 3 preferably corresponding to a quarter of the wavelength of the measurement signals have been described. With reference to FIG. 8, an alternative probe coupling device will be described, in which the key parameter is the distance between the coupling segments. Although, for the sake of brevity, a single example of such a coupling device is described herein, it should be understood that corresponding variations as those described above can be implemented analogously.

In FIG. 8, an exemplary probe coupling device 110 is shown, comprising three coupling segments 111, 112, 113 which are arranged along the probe 3 and mutually spaced apart along the probe 3 by a distance corresponding to a quarter of a wavelength of the measurement signals.

The center coupling segment 112 is configured to couple signals with a higher coupling efficiency than its neighbors, and this is here realized by positioning the center coupling segment 112 closer to the probe 3.

Through this probe coupling configuration, a wideband coupling can be realized having a coupling spectrum such as that shown in FIG. 6b.

Finally, with reference to FIG. 9, a radar level gauge system which is configured to determine an additional process variable of the product contained in the tank, in addition to the filling level, will be described.

In FIG. 9, a radar level gauge system 120 is schematically shown, comprising a control unit (CU) 121 and a transceiver (Tx/Rx) 122 contained in a housing 123, a probe 124 which is mechanically and electrically connected to the tank ceiling 23 via a flange 125, and a probe coupling device 126 which, through a feed-through 127 in the flange 125, is connected to the transceiver 122 and configured to couple electromagnetic measurement signals between the transceiver 122 and the probe 124. The probe 124 is further configured to support at least a first sensing device 128 at its distal end, and to enable connection between the sensing device 128 and the control unit 121 disposed outside the tank.

This connection is here realized by means of electric wiring 130 which is enclosed in the hollow probe 124 and which passes to the control unit 121 through a through-connection 131, which here coincides with the mechanical connection between the probe 124 and the flange 125.

As described above, the distance D (=a first process variable PP₁) to the surface 7 of the product contained in the tank may, for example, be 15 determined by determining the time between a transmitted pulse and its corresponding reflection pulse. Additionally, a second process variable PP₂, which may be temperature, pressure, pH, flow, water concentration etc, is determined based upon a signal from the sensing device 128 supported by the probe 124.

An output from the radar level gauge system 120 may then, as illustrated in FIG. 9, include a signal indicative of a plurality of process variables PP₁, PP₂, . . . of the product contained in the tank.

The probe 124 may be configured to support a sensor at the position along the probe 124 indicated in FIG. 9, or may be configured to support sensors configured to measure one or several process parameter at several positions along the probe 124. Particularly for temperature measurements, a stratified measurement is often important as the volume expansion may typically be in the order of 0.1% per degree and the average temperature therefore may have to be known at a high accuracy even in cases when the product at different locations along the probe may have several degrees difference in temperature. This may, for example, be the case if product has been provided to the tank from different sources.

The connection from the sensing device(s) to the outside of the tank may be effected through designated wiring or, alternatively, through the probe itself. In the former case, the wiring should preferably be arranged such as to cause a minimum of disturbance to the wave-guiding function of the probe, and in the latter case, a sensing device signaling scheme should be adapted such that signals between the sensing device and a sensing device control unit disposed outside the tank can be carried by the probe in addition to the guided electromagnetic signals to be reflected on a material interface in the tank. According to a further alternative implementation, the communication between the sensing device and its control circuitry can be temporally separated from intermittently occurring level determination events.

It should be noted that the radar level gauge system supporting one or several sensing devices for sensing one or several additional process variables, in addition to the distance to the surface of the product contained in the tank may alternatively not be in direct electrical connection with a conductive tank structure, such as the tank wall in the case of a conductive tank. In this case, a more conventional probe coupling device is combined with the ability of the probe to support one or several sensing devices, which is described above in connection with FIG. 9.

The person skilled in the art realizes that the present invention by no means is limited to the preferred embodiments described above. For example, the transceiver, control unit or any other processing circuitry may be positioned inside the tank rather than on the outside. Furthermore, a coupling segment length and/or spacing other than a quarter of the measurement signal wavelength may in some cases be advantageous. Moreover, several sensing devices adapted to measure the same or different process variable may be supported by the probe at different distances from the tank ceiling.

1. A radar level gauge system, for determining a filling level of a product contained in a tank, said radar level gauge system comprising:
a transceiver configured to transmit and receive electromagnetic signals;
a probe arranged to extend towards and into said product inside the tank and configured to guide transmitted signals towards a surface of said product, where signals are reflected, and reflected signals back from said surface of the product, said probe having a mechanical and direct electrical connection to a conductive tank structure;
processing circuitry connected to said transceiver and configured to determine said filling level based on said transmitted and reflected signals; and
a probe coupling device connected to said transceiver, said probe coupling device including:
a first coupling segment configured to couple electromagnetic signals between said transceiver and said probe with a first coupling efficiency; and
a second coupling segment configured to couple electromagnetic signals between said transceiver and said probe with a second coupling efficiency, said second coupling efficiency being different from said first coupling efficiency.

2. The radar level gauge system according to claim 1, wherein said first and second coupling segments are spaced apart along said probe in a longitudinal direction thereof.

3. The radar level gauge system according to claim 1, wherein:
said transceiver is arranged outside said tank; and
said probe coupling device is arranged inside said tank and connected to said transceiver by means of a feed-through provided in a wall of said tank.

4. The radar level gauge system according to claim 1, wherein said probe coupling device is galvanically isolated from said probe.

5. The radar level gauge system according to claim 1, wherein said probe coupling device further comprises a third coupling segment, and said first, second and third coupling segments are spaced apart along said probe in a longitudinal direction thereof.

6. The radar level gauge system according to claim 5, wherein each of said coupling segments extends essentially in parallel with said probe over a distance of substantially a quarter of a wavelength of a center frequency of said electromagnetic signals.

7. The radar level gauge system according to claim 5, wherein said first coupling segment is configured to couple said electromagnetic signals with a higher coupling efficiency than an adjacent coupling segment.

8. The radar level gauge system according to claim 7, wherein each of said coupling segments is galvanically isolated from said probe, and said first coupling segment is positioned closer to said probe than said adjacent coupling segment.

9. The radar level gauge system according to claim 7, wherein each of said coupling segments is galvanically isolated from said probe, and said probe coupling device further comprises a coupling enhancing member arranged to increase the coupling between said first coupling segment and said probe.

10. The radar level gauge system according to claim 9, wherein said coupling enhancing member comprises a conductive structure positioned between said first coupling segment and said probe.

11. The radar level gauge system according to claim 5, wherein said coupling segments are mutually spaced apart by a distance of substantially a quarter of a wavelength of a center frequency of said electromagnetic signals.

12. The radar level gauge system according to claim 11, wherein said first coupling segment is configured to couple said electromagnetic signals with a higher coupling efficiency than an adjacent coupling segment.

13. The radar level gauge system according to claim 12, wherein each of said coupling segments is galvanically isolated from said probe, and said first coupling segment is positioned closer to said probe than said adjacent coupling segment.

14. The radar level gauge system according to claim 12, wherein each of said coupling segments is galvanically isolated from said probe, and said probe coupling device further comprises a coupling enhancing member arranged to increase the coupling between said first coupling segment and said probe.

15. The radar level gauge system according to claim 14, wherein said coupling enhancing member comprises a conductive structure positioned between said first coupling segment and said probe.

16. The radar level gauge system according to claim 1, wherein said transceiver is configured to transmit and receive electromagnetic signals modulated on a carrier.

17. The radar level gauge system according to claim 16, wherein said carrier has a frequency above 0.5 GHz and below 2 GHz.

18. The radar level gauge system according to claim 1, wherein said probe is in metallic contact with said tank structure.

19. The radar level gauge system according to claim 1, further comprising at least a first sensing device for sensing at least a first additional process variable inside said tank, such as a temperature of said product contained in the tank.

20. The radar level gauge system according to claim 19, further comprising a through-connection through a tank wall for enabling connection between said first sensing device and an outside of the tank.

21. The radar level gauge system according to claim 20, wherein said probe is further configured to support said at least first sensing device at a first sensor position along the probe.

22. The radar level gauge system according to claim 21, wherein said probe comprises a hollow probe section for encasing electric wiring between said first sensor position and said through-connection.

23. The radar level gauge system according to claim 22, wherein said through-connection is formed by said hollow probe section extending through said tank wall.

24. The radar level gauge system according to claim 19, further comprising a second sensing device for sensing a second process variable inside said tank.

101-124. (canceled)
